(19) United States
(12) Patent Application Publication
(10) Pub. No.: US 2008/0290225 A1
(43) Pub. Date: Nov. 27, 2008

(54) Infant Bottle Holder

(75) Inventor: Peter Mostert, Long Beach, CA (US)

Correspondence Address: LOZA & LOZA LLP, 305 N. Second Avenue, #127, Upland, CA, 91786-6064, US

(73) Assignee: HICO INC., Encino, CA (US)

(21) Appl. No.: 12/123,017

(22) Filed: May 19, 2008

Related U.S. Application Data
(60) Provisional application No. 60/940,397, filed on May 26, 2007.

(51) Int. Cl. A61J 9/06

(52) U.S. Cl. 248/102

(57) ABSTRACT

A wearable infant bottle holder is provided comprising a neck strap, a base component, and a bottle-securing coupler. The neck strap allows supporting the bottle holder around a user's neck. The base component attaches to the neck strap. The bottle-securing coupler is adjustable to secure a bottle to the upper component while allowing adjustment of the angle of the bottle relative to the base component. The bottle-securing coupler may be removably coupled to the upper component or it may be rotatably coupled to the base component. The bottle-securing coupler may include an upper component and a band. The neck strap may include an adjuster that allows adjusting the length of the strap longer or shorter without removing the strap.

### CLAIM OF PRIORITY UNDER 35 U.S.C. §119

The present Application for Patent claims priority to U.S. Provisional Application No. 60/940,397 entitled “Infant Bottle Holder” filed May 26, 2007, and is hereby expressly incorporated by reference herein.

### FIELD

The invention relates to the field of infant bottle holders, in particular, to a wearable item that can hold the bottle while feeding the baby.

### BACKGROUND

When feeding an infant with a bottle, a person often holds the infant with one arm/hand, while the other hand holds the bottle so that the infant can be fed. Consequently, if the person needs use a hand while feeding the baby (e.g., wiping the baby's face, answering the telephone, etc.) it can be quite cumbersome and the feeding of the baby may be interrupted. Interrupting a baby's feeding can be frustrating for a hungry child and may cause unnecessary crying.

A bottle holder allows the person feeding the baby to, for example, use their other hand to attend to another child, drink or eat, wipe the baby's face and/or mouth, change a channel on television, or even read to the child.

Some prior art bottle holders allow a person feeding the baby to have one hand free while the bottle holder holds the bottle so that the baby can eat. However, people who have fed babies know that there are instances it is necessary to change the arm on which the baby is resting. Also, it is often necessary to adjust the angle and/or position of the bottle as the baby drinks the formula or milk inside. If air remains in the nipple, then the baby may end up swallowing gas bubbles creating a bloated and unhappy baby. Finally, it is important that if the person feeding the baby needs to change his or her position they can do so and easily adjust the holder so the baby's feeding is not interrupted in any way. Prior art bottle holders typically do not provide an easy way to change feeding arms and/or adjust the angle or position of the bottle.

Consequently, a bottle holder is needed that can allow the baby to be easily moved from arm to arm during a feeding with very little interruption. It is also important to have the bottle easily rotate or adjust its position on the holder so that no air remains in the nipple during the feeding. Additionally, if the person needs to change his or her position or feeding arm, it is important that the baby can be fed and the holder can be adjusted quickly to avoid interrupting the infant's feeding.

### SUMMARY

A wearable infant bottle holder is provided comprising a neck strap, a base component, and a bottle-securing coupler. The neck strap allows supporting the bottle holder around a user's neck. The base component attaches to the neck strap. The bottle-securing coupler is adjustable to secure a bottle to the upper component while allowing adjustment of the angle of the bottle relative to the base component. The bottle-securing coupler may be removably coupled to the upper component or it may be rotatably coupled to the base component. The bottle-securing coupler may include an upper component and a band. The neck strap may include an adjuster that allows adjusting the length of the strap longer or shorter without removing the strap.

In one example, the wearable infant bottle holder may comprise a neck strap, a base disc, an upper cover, and a bottle-securing band. The upper cover may be rotatably attached to the base disc. The bottle-securing band may be adjustable to secure a bottle to the upper cover. The bottle-securing band may be removably coupled to the upper cover thereby allowing adjustment of the angle of the bottle-securing band in relation to the base disc. For instance, the upper cover may be rotated a full circle relative to the base disc. The base disc and upper cover may be adapted to allow a bottle to be securely held by the bottle-securing band at a desired angle. The securing band may be detachable from the upper cover to remove a bottle. The securing band may have an inside portion that is coated with rubber strips to allow for a better grip with the bottle.

A coupler may be attached between the base disc and the upper cover to thereby allow the upper cover to rotate relative to the base disc and facilitate positioning of a baby bottle held by the bottle-securing band at a desired angle.

The strap may be detachably coupled to the base disc. The neck strap may have an adjuster that allows adjusting the length of the strap longer or shorter without removing the strap.

A second example provides a wearable infant bottle holder comprising: a neck strap, a base component attached to the neck strap, and a bottle-securing coupler coupled to the base component. The bottle-securing coupler may be adaptable to secure a bottle where the angle of the bottle-securing coupler being adjustable relative to the base component.

The neck strap may be adjustable to be worn around a user's neck and thereby support the holder. The bottle-securing coupler may be detachably coupled to the base component. The bottle-securing coupler may be rotatably coupled to the base component.

In one implementation, the bottle-securing coupler may include (a) an upper component coupled to the base component, and (b) a band coupled to the upper component that wraps at least partially around the bottle to secure it. The upper component may be detachably coupled to the base component thereby allowing the angle of the bottle to be adjusted relative to the base component. The upper component may also be rotatably coupled to the base component thereby allowing the angle of the bottle to be adjusted relative to the base component.

Consequently, an infant bottle holder is provided comprising: (a) means for supporting the holder from a user's neck, (b) means for securing a bottle, (c) means for securely adjusting the angle of the bottle to a desired position, (d) means for rotating the bottle while secured to the holder, and/or (e) means for detaching the bottle from the holder to adjust its angle.

### BRIEF DESCRIPTION OF THE DRAWINGS

Various features, nature, and advantages may become apparent from the detailed description set forth below when taken in conjunction with the drawings in which like reference characters identify correspondingly throughout.

FIG. 1 illustrates a perspective view of the entire assembled infant bottle holder holding a bottle.

FIG. 2 illustrates another view of the infant bottle holder with the bottle removed.

FIG. 3 illustrates a cross-sectional view of the infant bottle holder.

FIG. 4 illustrates a close-up view of the securing band 104 coupled to the upper cover without a bottle.

FIG. 5 illustrates an example of infant bottle holder having a removable upper cover.

FIG. 6 illustrates views of the bottle holder 100 in three different positions.

### DETAILED DESCRIPTION OF THE INVENTION

In the following detailed description of the invention, numerous specific details are set forth in order to provide a thorough understanding of the invention. However, the invention may be practiced without these specific details. In other instances well known methods, procedures, and/or components have not been described in detail so as not to unnecessarily obscure aspects of the invention.

One aspect of the present invention provides an infant bottle holder having an adjustable strap and a rotating bottle holder base. A band is attached to the rotating base, where the band can wrap or stretch tightly around any diameter bottle. The rotating base allows the bottle to be adjusted or tilted at such an angle that the milk or formula in the bottle always fills the nipple of the bottle. An adjustable strap is placed around the neck of a wearer or user to support the bottle holder during feeding. The adjustable strap and rotating base allows the wearer/user to easily change sides so that the baby can be fed while resting on either the right or left arm of the wearer and can be moved easily during the feeding without interrupting the feeding. Additionally, the length of the strap may be adjustable to account for the size of different wearers/users or the preferences different wearers/users may have in how close and/or on which arm they like to hold the baby during a feed.

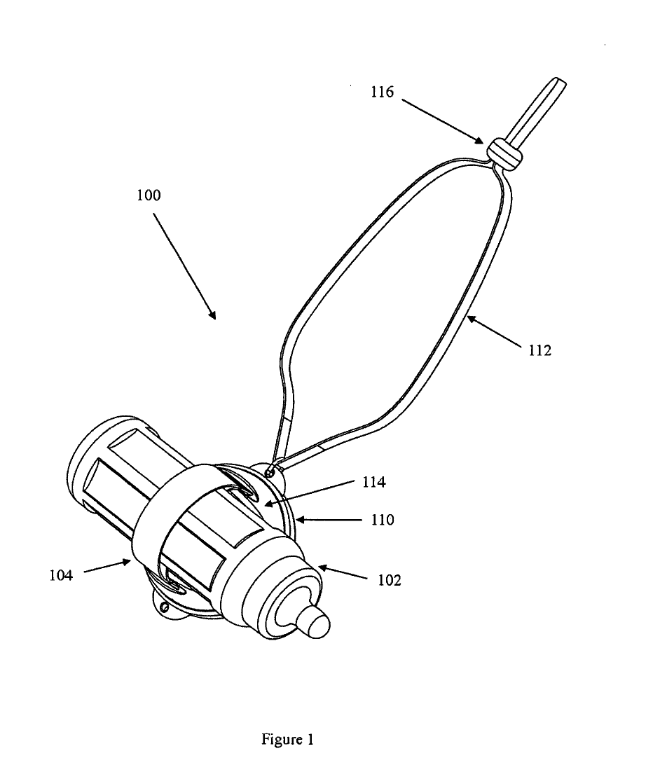

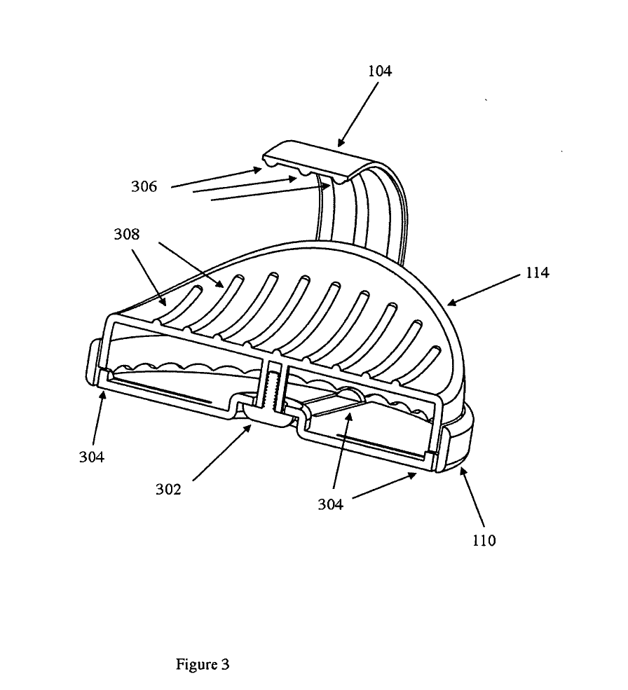

FIG. 1 illustrates a perspective view of an example of an assembled infant bottle holder 100 holding a bottle 102. The bottle holder 100 may include a base disc 110 attached to a strap 112 that the wearer/user feeding the baby can wear around his/her neck. A securing band 104 may be coupled to the upper cover 114 and can be stretched or wrapped around the bottle 102 to secure it. The strap 112 may also have a sliding bead 116 that allows the wearer/user to change the length of the strap 112 to thereby adjust the position of the bottle for feeding. The upper cover 114 may be attached to the base disc 110 by a fastener 302 (FIG. 3) that permits the upper cover 114 to rotate relative to the base disc 110. The securing band 104 may be sized to stretch around a bottle of almost any size. A bottle may be changed by simply sliding it out of the securing band 104 and sliding in a new bottle.

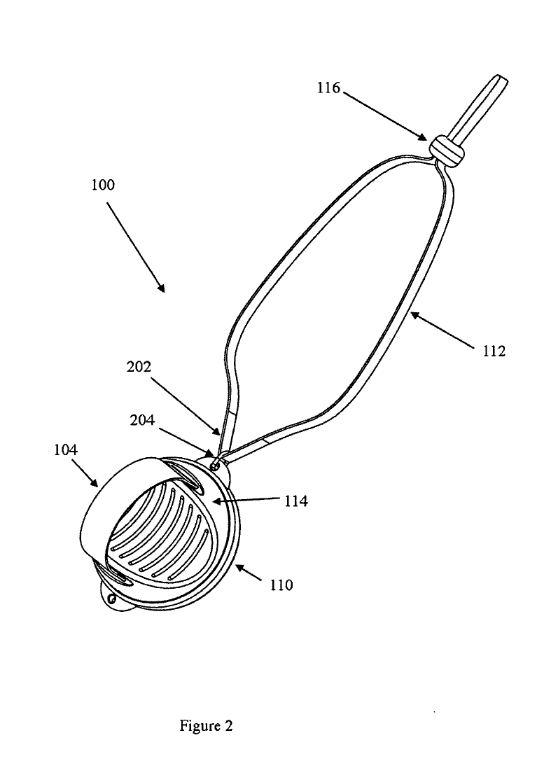

FIG. 2 illustrates another view of the infant bottle holder 100 with the bottle removed.

FIG. 3 illustrates cross-sectional view of the infant bottle holder 100. A fastener 302 attaches the base disc 110 to the upper cover 114 while allowing the upper cover 114 to rotate. In one example, the base disc 110 may include an opening through with the fastener passes and engages the upper cover 114. The base disc 110 and upper cover 114 may have a substantially circular perimeter. According to an optional feature, fastener 302, base disc 110 and/or upper cover may be shaped and/or configured so that there is a slight resistance to the rotation of the upper cover 114 relative to the base disc 110. This may allow the bottle (coupled to the upper cover 114) to stay in an intended position and not rotate accidentally or suddenly. For instance, one example may employ ratcheting teeth 304 between the base disc 110 and upper cover 114) that allow the upper cover 114 to turn only when a certain amount of torque is applied to the bottle either by the baby or the user/wearer of the device 100. In another implementation the fastener 302 may have a large head that is easily adjustable by the wearer/user to be tighter or looser, thereby allowing the user/wearer to adjust the amount of rotational resistance by increasing or decreasing the amount of interference with the ratchet teeth 304. Other methods may be used to create the rotational resistance such as friction plates, magnets, etc., without deviating from the invention.

The strap 112 may be designed to be quickly detachable from the base disc 110. This may allow the wearer/user to quickly remove the infant bottle holder 100 without lifting the neck strap 112 up and over his/her head. For example, a first end 202 (FIG. 2) of the strap 112 may include a finger operated spring hook attachment that attaches to a ring 204 on the base disc 110. Alternatively, the first end 202 may wrap around the ring 204 and attach back on itself with a loop-and-hook material (e.g., Velcro™) or a snap fastener.

The bottle securing band 104 is preferably made out of a material that can be adjusted to fit any size bottle snugly such as elastic material. In some implementations, the securing band 104 may include an elastic material that expands to allow a bottle to be inserted and then contracts to keep it place. In other implementations, the securing band 104 may open and close to allow to insertion and/or removal of the bottle from the holder.

In one implementation, a rubber or plastic material 306 may be included on the inside of the securing band 104 to prevent slippage of the bottle during feeding. The upper cover 114 may have a curved shape to engage against a bottle and help to maintain it in place. In another implementation, rubber material may be added in the form of ribs 308 on a curved shape of the upper cover 114 that presses against the bottle 102. The securing band 104 may be made of any material sufficiently suitable to secure a feeding bottle, such as a elastic, or a loop-and-hook material.

The securing band 104 can be of any width. However, it may be advantageous to make the band 104 small enough so that the amount of liquid remaining in the bottle can be seen by the user/wearer and the feeding can stop when there is no more fluid. Additionally, it is sometimes important to burp babies periodically throughout a feeding and most parents burp by observing the amount of fluid the baby has consumed and stopping the feeding every quarter or half of the bottle.

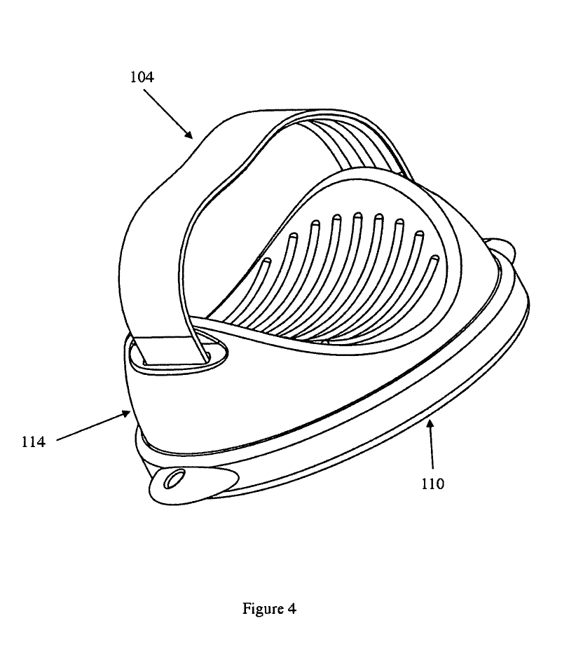

FIG. 4 illustrates a close-up view of the securing band 104 coupled to the upper cover 114 without a bottle.

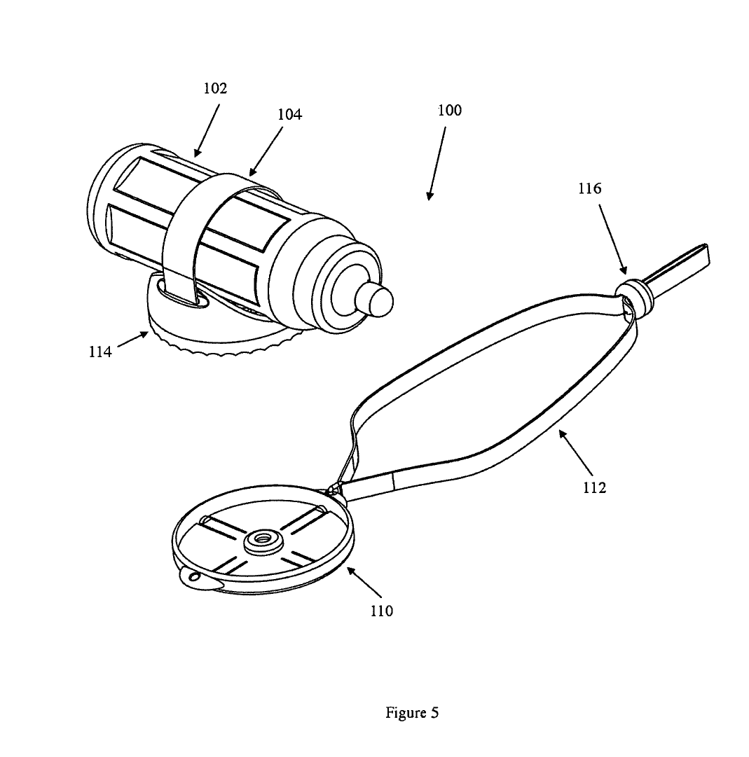

FIG. 5 illustrates an example of infant bottle holder having a removable upper cover. Instead of using the fastener 302 to hold the base disc 110 and the upper cover 114 together, the upper cover 114 may be removably attached to the base disc 110 by snapping them together (e.g., pressure fitting) while allowing them to rotate relative to each other. This may allow the user/wearer to have several bottles 102 ready and attached to several additional upper covers 114 so the user can quickly unsnap the upper cover 114 with the consumed empty bottle 102 and snap on a new upper cover 114 with a full bottle 102.

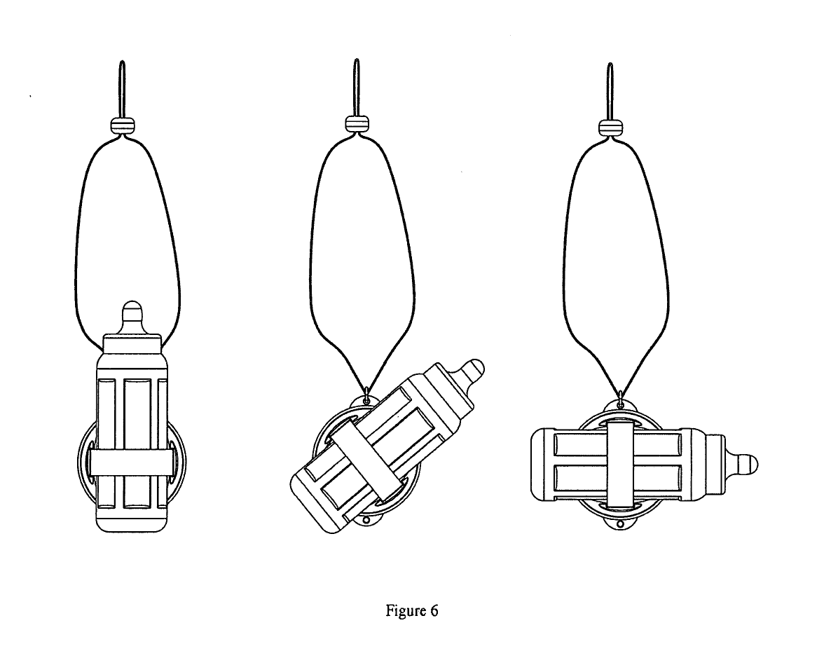

FIG. 6 illustrates views of the bottle holder 100 in three different positions. The rotation of the upper cover 114 relative to the base disc 110 allows the user/wearer to place the bottle in any position in relation to the base disc 110. This allows the user/wearer to place the bottle in a substantially vertical position, while the baby is not being fed, or in substantially horizontal position when the baby is being fed.

In an alternative embodiment, multiple base discs and securing bands may be attached to the strap 112 to assist in the feeding of twins, for example. This configuration may also allow having two or more bottles handy if the first bottle is not large enough to contain enough milk for that particular infant.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A wearable infant bottle holder comprising:
a neck strap that allows supporting the bottle holder;
a base disc attached to the neck strap;
an upper cover rotatably attached to the base disc;
a bottle-securing band adjustable to secure a bottle to the upper cover.

2. The holder of claim 1, wherein the bottle-securing band is removably coupled to the upper cover thereby allowing adjustment of the angle of the bottle-securing band in relation to the base disc.

3. The holder of claim 1 wherein the strap is detachably coupled to the base disc.

4. The holder of claim 1 wherein the base disc and upper cover are adapted to allow a bottle to be securely held by the bottle-securing band at a desired angle.

5. The holder of claim 1 further comprising:
a coupler attached between the base disc and the upper cover thereby allowing the upper cover to rotate relative to the base disc and facilitating positioning of a baby bottle held by the bottle-securing band at a desired angle.

6. The holder of claim 1 wherein the upper cover can be rotated a full circle relative to the base disc.

7. The holder of claim 1 wherein the neck strap has an adjuster that allows adjusting the length of the strap longer or shorter without removing the strap.

8. The holder of claim 1 wherein the securing band is detachable from the upper cover to remove a bottle.

9. The holder of claim 1 wherein the securing band has an inside portion that is coated with rubber strips to allow for a better grip with the bottle.

10. A wearable infant bottle holder comprising:
a neck strap;
a base component attached to the neck strap;
a bottle-securing coupler coupled to the base component and adaptable to secure a bottle, the angle of the bottle-securing coupler being adjustable relative to the base component.

11. The holder of claim 10, wherein the neck strap is adjustable to be worn around a user's neck and thereby support the holder.

12. The holder of claim 10, wherein the bottle-securing coupler is detachably coupled to the base component.

13. The holder of claim 10, wherein the bottle-securing coupler is rotatably coupled to the base component.

14. The holder of claim 10, wherein the bottle-securing coupler includes
an upper component coupled to the base component, and
a band coupled to the upper component that wraps at least partially around the bottle to secure it.

15. The holder of claim 14, wherein the upper component is detachably coupled to the base component thereby allowing the angle of the bottle to be adjusted relative to the base component.

16. The holder of claim 14, wherein the upper component is rotatably coupled to the base component thereby allowing the angle of the bottle to be adjusted relative to the base component.

17. An infant bottle holder comprising:
means for supporting the holder from a user's neck;
means for securing a bottle; and
means for securely adjusting the angle of the bottle to a desired position.

18. The holder of claim 17, further comprising:
means for rotating the bottle while secured to the holder.

19. The holder of claim 17, further comprising:
means for detaching the bottle from the holder to adjust its angle.
